(19) United States
(12) Patent Application Publication
(10) Pub. No.: US 2005/0219035 A1
(43) Pub. Date: Oct. 6, 2005

(54) Variable electronic component

(75) Inventor: Akiko Iura, Kyoto-shi (JP)

Correspondence Address: Hamre, Schumann, Mueller & Larson, P.C., P.O. Box 2902-0902, Minneapolis, MN, 55402, US

(73) Assignee: ROHM CO., LTD., Kyoto-shi (JP)

(21) Appl. No.: 11/068,569

(22) Filed: Feb. 28, 2005

(30) Foreign Application Priority Data
Feb. 27, 2004 (JP) 2004-54143

(51) Int. Cl. H01C 10/32

(52) U.S. Cl. 338/162

(57) ABSTRACT

The invention relates to a variable electronic component that can adjust an electrical characteristic such as a resistance value, preferably applicable to a chip-type variable resistor. The chip-type variable resistor includes an insulating substrate 1 and a rotor 5 rotatably mounted on the upper face of the insulating substrate 1. The rotor 5 includes a cup-shaped member 6 and a ring-shaped sliding member 7 integrally connected via a hinge portion 8 and is rotatably mounted to the upper surface of the insulating substrate by calking. The flange of the cup-shaped member includes a movable stopper projecting downward, and the insulating substrate 1 includes an upwardly open groove 16 that allows the movable stopper 15 to rotate. End portions 16a of the upwardly open groove 16 are intruding into an inner region of the insulating substrate 1 from the side face thereof.

### TECHNICAL FIELD

The present invention relates to a variable electronic component that can adjust an electrical characteristic such as a resistance value, and more particularly to a chip-type variable resistor.

### BACKGROUND ART

In general, a chip-type variable resistor (or a chip-type semi-fixed resistor) includes an insulating substrate made of a ceramic and having a center hole penetrating in a thicknesswise direction, a terminal board made of a metal plate and having a center shaft fitted from below to the center hole, and a rotor made of a metal plate, mounted on an upper face of the insulating substrate so as to rotate around the center shaft.

The rotor is constituted of two or three layers. The two-layer rotor includes an upwardly open cup-shaped member with a flange outwardly extending from an upper end portion of the cup-shaped portion, and a ring-shaped sliding member disposed under the flange so as to surround the cup-shaped member, and the flange of the cup-shaped member and the ring-shaped sliding member are integrally connected via a hinge portion. The three-layer rotor has a similar structure to that of the two-layer rotor, except that the former includes two ring-shaped sliding members.

The cup-shaped member is provided with an engaging portion (hole or groove) with which a rotation adjusting driver is engaged. The ring-shaped sliding member is provided with a contact located opposite to the hinge portion, so as to contact a resistor film provided on the upper face of the insulating substrate. The resistor film is coated on the upper face of the insulating substrate so as to extend in a U-shape in a plan view. The end portions of the resistor film are partly overlapping side electrodes coated on side faces of the insulating substrate. The terminal board is provided with a counter electrode bent upward at a position opposite to the side electrode across the rotor, and the counter electrode of the terminal board and the two side electrodes are soldered to a circuit board.

Such a chip-type variable resistor generally includes a stopper that delimits the maximum rotation angle of the rotor. The chip-type variable resistor disclosed in JP-A 11-16709 (Patent Document 1) and JP-A 2000-353607 (Patent Document 2), for example, is provided with a fixed stopper erecting upward on the terminal board at a position outer than the outer face of the insulating substrate, and a pair of movable stoppers (projections) located on the respective end portions of the hinge portion of the ring-shaped sliding member, which engages with the fixed stopper when rotating the rotor. In this case, the terminal board and the cup-shaped member are also utilized as the stoppers, given the structure that the cup-shaped member and the terminal board are electrically connected.

The resistance value of such a chip-type variable resistor is adjusted after being soldered onto a printed board. However, in the case of the chip-type variable resistor disclosed in Patent Document 1 or 2, when the rotor is rotated in such a large angle that the projection of the rotor is butted to the fixed stopper on the terminal board while adjusting the resistance value, the soldered portion of the terminal board, or a part of the solder often comes off, because of the impact. Otherwise, the fixed stopper on the terminal board and/or the movable stopper (projection) of the rotor is prone to be deformed as a result of repeated adjustment of the resistance value, thus to no longer serve as a stopper.

Meanwhile, the chip-type variable resistor disclosed in JP-A 2000-340410 (Patent Document 3) is provided with a fixed stopper at an edge of the center hole of the insulating substrate, and a movable stopper (armature) formed on the cup-shaped member so as to engage with the fixed stopper.

In the resistor according to Patent Document 3, however, the cup-shaped member has a larger outer diameter than the inner diameter of the center hole of the insulating substrate, and hence a large moment is applied to the armature (movable stopper) by the rotation of the cup-shaped member (rotor). This may lead to various troubles such as deformation of the armature upon collision to the fixed stopper or emergence of waste (powder from the substrate) resultant from friction between the armature of the cup-shaped member and a stepped portion of the insulating substrate, and further such waste may intrude into a pinched portion to thereby affect the fixing strength, or fall onto the circuit board through the center hole thus causing a malfunction of the circuit. In addition, according to Patent Document 3, the cup-shaped member is fixed in a cantilever form at its inner circumferential edge, by the center shaft. Therefore the rotor is not retained with a sufficient strength, and hence prone to lose the proper posture after repeated adjustment of the resistance value, thus to end up becoming useless.

### DISCLOSURE OF THE INVENTION

Accordingly, it is an object of the present invention to eliminate or minimize the foregoing problems observed in the conventional techniques.

The present invention provides a variable electronic component comprising an insulating substrate, and a rotor rotatably mounted on an upper face of the insulating substrate. The rotor includes a movable stopper that is brought into direct contact with an outer surface of the insulating substrate for delimiting a maximum rotation angle of the rotor.

According to present invention, the movable stopper directly contacts the outer surface of the insulating substrate to thereby delimit the maximum rotation angle. Such a structure eliminates the problems including separation or degradation in adhesion of the solder, which is incurred when a terminal board is also used as a stopper, deformation of the terminal board that results in loss of the stopper function, and emergence of waste and degradation in strength to keep the rotor fixed, resultant from disposing a fixed stopper close to an edge of a center hole of the insulating substrate. Consequently, a highly reliable and high-quality variable electronic component can be attained.

Preferably, the rotor is made of a metal plate, and includes an upwardly open cup-shaped member with a flange outwardly extending from an upper end portion of the cup-shaped portion, and a ring-shaped sliding member disposed under the flange so as to surround the cup-shaped member. The flange of the cup-shaped member and the ring-shaped sliding member are integrally connected via a hinge portion. The cup-shaped member includes an engaging portion with which a rotation adjusting driver is engaged, while the ring-shaped sliding member includes a contact located opposite to the hinge portion across the center axis of the ring-shaped sliding member for contacting a characteristic adjusting film provided on the upper surface of the insulating substrate. The movable stopper is an armature downwardly extending to a lower level than the upper face of the insulating substrate from the flange of the cup-shaped member.

Preferably, the movable stopper is located in a region opposite to the hinge portion on the flange of the cup-shaped member, and the insulating substrate includes an upwardly open groove or a stepped portion formed on the upper surface for allowing the movable stopper to rotate reciprocatively. Such configuration offers the advantage of making the variable electronic component smaller in dimensions, since the distance between the rotation center of the rotor and the movable stopper can be shortened.

Preferably, the insulating substrate includes a cutaway portion that allows the movable stopper to intrude into an inner region of the insulating substrate through its side face, when the rotor is brought close to a rotational limit. Such configuration allows expanding the rotation angle range of the rotor and hence the adjustment range of a characteristic value, thereby upgrading the performance of the electronic component.

The present invention may be suitably applied to a chip type variable resistor, in which case the adjusting film is a resistor film.

The above and other features and benefits of the present invention will become more apparent from the following embodiments to be described referring to the accompanying drawings.

### BRIEF DESCRIPTION OF THE DRAWINGS

FIG. 1 is a plan view showing a resistor according to a first embodiment of the present invention;

FIG. 2 is a cross-sectional view taken along the line II-II of FIG. 1;

FIG. 3 is an exploded perspective view showing the resistor according to the first embodiment;

FIG. 4 is a partially cross-sectional plan view showing the resistor according to the first embodiment;

FIG. 5 is a partially cross-sectional plan view showing a resistor according to a second embodiment;

FIG. 6 is a partially cross-sectional plan view showing a resistor according to a third embodiment; and

FIG. 7 is a vertical cross-sectional view showing a resistor according to a fourth embodiment.

### BEST MODE FOR CARRYING OUT THE INVENTION

Hereunder, a chip-type variable resistor (hereinafter, simply a “register”) according to preferred embodiments of the present invention will be described referring to the drawings.

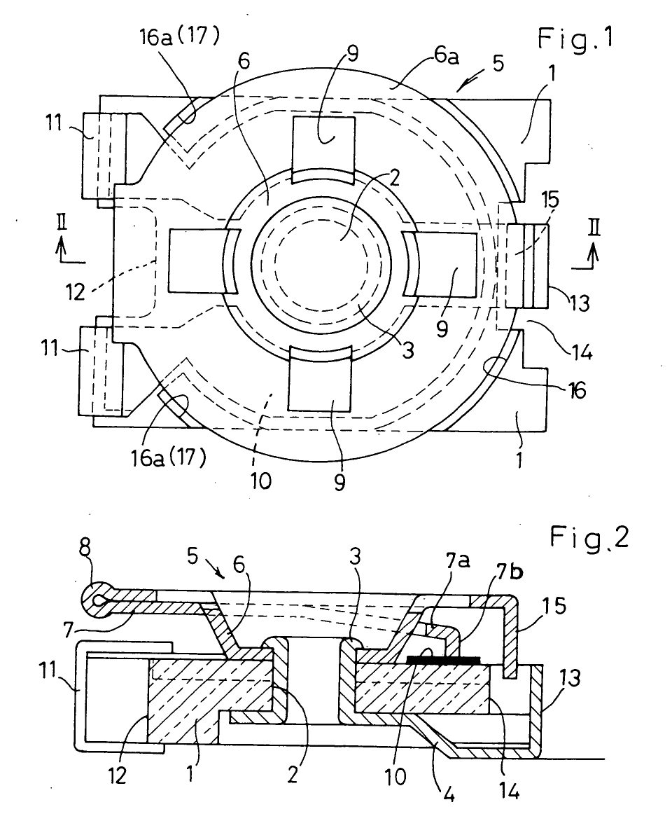

### (1) First Embodiment (FIGS. 1˜4)

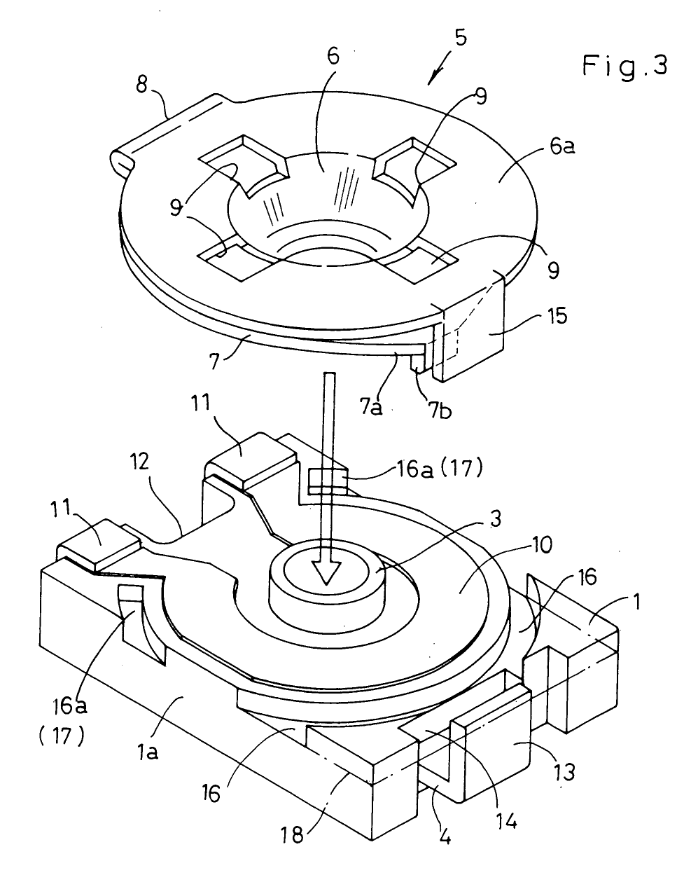

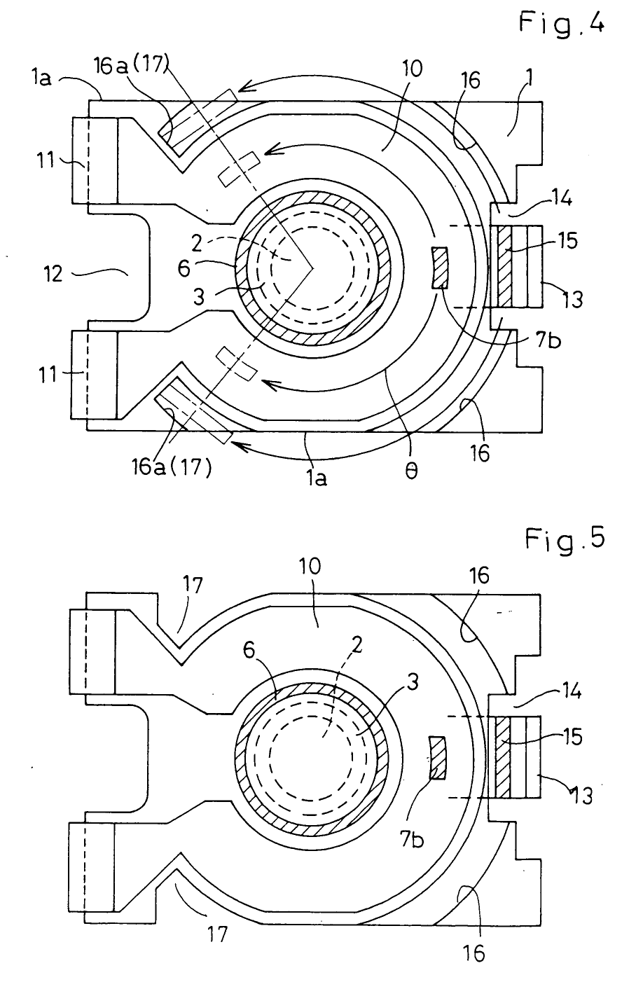

FIGS. 1 to 4 illustrate a resistor according to a first embodiment of the present invention. FIG. 1 is a plan view of the resistor; FIG. 2 is a cross-sectional view taken along the line II-II of FIG. 1; FIG. 3 is an exploded perspective view of the resistor; and FIG. 4 is a partially cross-sectional plan view of the same.

The resistor includes an insulating substrate 1 made of a ceramic or the like and having a vertically penetrating center hole 2, a terminal board 4 made of a metal plate and having a center shaft 3 fitted from below to the center hole 2, and a rotor 5 made of a metal plate, mounted on an upper face of the insulating substrate 1 so as to rotate around the center shaft 3. The insulating substrate 1 is of a generally rectangular shape in a plan view.

The rotor 5 includes an upwardly open cup-shaped member 6 with a flange 6a outwardly extending from an upper end portion of the cup-shaped portion, and a ring-shaped sliding member 7 disposed under the flange 6a so as to surround the cup-shaped member 6, and the flange 6a of the cup-shaped member 6 and the ring-shaped sliding member 7 are integrally connected via a hinge portion 8. The cup-shaped member 6 is rotatably pinched to the upper face of the insulating substrate 1, by the center shaft 3 of the terminal board 4. Alternatively, the insulating substrate 1 may be provided with a recessed portion on the upper face, in which a portion of the cup-shaped member 6 can be accommodated, so that the cup-shaped member 6 is pinched to the recessed portion. Such modification is duly included in the scope of the present invention. Also, the upwardly expanding cup-shaped member 6 of the rotor 5 may be formed in a cylindrical shape instead.

On the upper surface of the insulating substrate 1, a resistor film 10 is coated over a U-shaped region in a plan view so as to surround the center shaft 3. The respective end portions of the resistor film 10 is covered with a side electrode 11, which is exposed on a side face and lower face of the insulating substrate 1. The insulating substrate 1 includes a first cutaway portion 12 formed in a region between the side electrodes 11. The first cutaway portion 12 serves to prevent bridging of a solder, i.e. to prevent the solder that binds the side electrodes 11 from being connected when implementing the resistor on a printed board.

The terminal board 4 includes a counter electrode 13 erected upward along the side face of the insulating substrate 1 at a position opposite to the side electrodes 11 across the center hole 2.

The cup-shaped member 6 constituting a part of the rotor 5 includes a driver hole 9, which is an embodiment of the engaging portion for the driver, punched in a Phillips head shape (or standard slot shape) in a plan view. The ring-shaped sliding member 7 is overlapping approximately a half portion of the flange 6a of the cup-shaped member 6 on the side of the hinge portion 8, and includes a slope portion 7 extending obliquely downward from such overlapping portion, toward the resistor film 10. The tip portion 7a of the slope portion 7 includes a contact 7b disposed in sliding contact with the resistor film 10.

As is apparent in view of FIG. 1, the side electrodes 11 are located on a short side of the rectangular-shaped insulating substrate 1. Also, the flange 6a of the cup-shaped member 6 is located inside the insulating substrate 1 in a longitudinal direction, however slightly protruding from the sides of the insulating substrate 1 in a widthwise direction, when viewed from above.

The insulating substrate 1 includes a second cutaway portion 14 of a stepped shape in a plan view, at a position corresponding to the counter electrode 13. Also, at a position opposite to the hinge portion 8 across the center axis, the flange 6a of the cup-shaped member 6 includes a downwardly extending movable stopper 15 partly intruding into the second cutaway portion 14 of the insulating substrate 1. Further, the insulating substrate 1 includes an upwardly open groove 16 that allows the movable stopper 15 to reciprocatively rotate in a horizontal direction.

Since the flange 6a of the cup-shaped member 6 has a larger diameter than the widthwise dimension of the insulating substrate 1, the upwardly open groove 16 is split at the longitudinal sides of the insulating substrate 1. In other words, the upwardly open groove 16 once vanishes at a side 1a of the insulating substrate 1, but reappears and intrudes into the insulating substrate 1 so as to constitute the end portion 16a which is extending up to the proximity of the side electrode 11. The end portion 16a of the upwardly open groove 16 serves as a movable stopper path 17 that provides a room for the movable stopper 15 to intrude into an inner region of the longitudinal side 1a when the rotor 5 is oriented close to the rotation terminal. In addition, the resistor film 10 and the side electrodes 11 are engaged with the insulating substrate 1 so as not to contact the movable stopper 15.

The counter electrode 13 is disposed along the short side of the insulating substrate 1 opposite to that provided with the side electrodes 11. According to this embodiment, the upper edge of the counter electrode 13 is generally aligned with the upper surface of the insulating substrate 1. Because of such configuration, the movable stopper 15 is shifted to a radially inner position than the counter electrode 13, to thereby prevent interference between the movable stopper 15 and the counter electrode 13.

According to this embodiment, the second cutaway portion 14 is provided throughout the entire thickness of the insulating substrate 1, and the upwardly open groove 16 is provided on the upper surface of the insulating substrate 1 so as to allow the movable stopper 15 to intrude. Alternatively, as indicated by an imaginary line in FIG. 3, the insulating substrate 1 may be formed in a stepped shape so that a region outside the traveling path of the movable stopper 15 becomes thinner. It is to be noted, however, the forming the upwardly open groove 16 is more advantageous because higher planarity can be achieved on the upper surface of the insulating substrate 1, which facilitates conveying the insulating substrate 1 by a parts feeder or adsorbing the same with a vacuum collet.

Under the foregoing configuration, the maximum rotation angle of the rotor 5 for adjusting a resistance value at a product inspection or after implementing the resistor on a printed board is delimited by the sidewall of the end portion 16a (movable stopper path 17) of the upwardly open groove 16, which blocks the rotation of the movable stopper 15. Since the insulating substrate 1 has a rigid structure by nature, there is no likelihood of being damaged or deformed by the collision of the movable stopper 15, and therefore excellent durability and quality can be assured.

The movable stopper 15 could be designed to rotate outside of the insulating substrate 1, however in this case the cup-shaped member 6 would inevitably have to have larger dimensions. From such a viewpoint, forming the upwardly open groove 16 on the insulating substrate 1 so as to allow the movable stopper 15 to travel therethrough as this embodiment offers the advantage that the resistor can be made in more compact dimensions.

Further, forming the end portion 16a of the upwardly open groove 16 from the side face of the insulating substrate 1 into an inner region thereof thus to constitute the movable stopper path 17 allows increasing the maximum rotation angle θ of the rotor 5, which naturally leads to expansion of the adjustment range of the resistor by the same extent.

### (2) Second to Fourth Embodiments (FIGS. 5˜7)

FIG. 5 is a partially cross-sectional plan view showing a resistor according to a second embodiment. In this embodiment, the movable stopper path 17 is constituted of a bay-shaped cutaway portion formed on the longitudinal sides of the insulating substrate 1. The structure of the remaining portions is the same as the first embodiment.

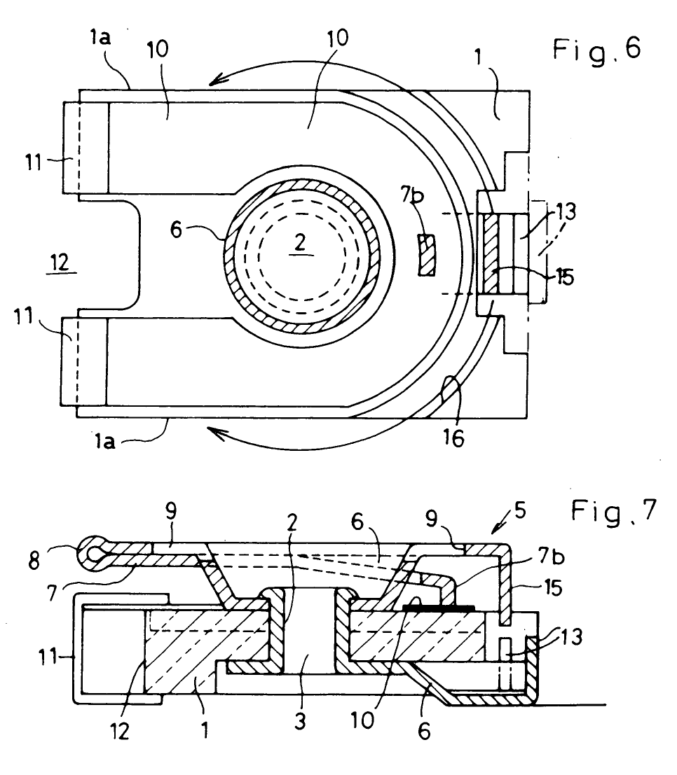

FIG. 6 illustrates a resistor according to a third embodiment. This embodiment does not include the cutaway portion, but delimits the maximum rotation angle of the rotor 5 at the point where the movable stopper 15 directly contacts the longitudinal sides of the insulating substrate 1. As indicated by a dash-dot line in FIG. 6, the short side of the insulating substrate 1 may be straightly continued all the way, instead of providing the second cutaway portion 14.

In a fourth embodiment shown in FIG. 7, the counter electrode 13 is disposed at an outer position than the movable stopper 15 so as to avoid the interference between the movable stopper 15 and the counter electrode 13, and also made lower than the lower edge of the movable stopper 15. For avoiding the interference between the movable stopper 15 and the counter electrode 13, it is only either of the horizontal positioning or the height of these parts that has to be modified. When the height is adjusted, the horizontal positioning may remain unchanged as indicated by a dash-dot line in FIG. 7.

The present invention may be modified in various manners without limitation to the foregoing embodiments. To cite a few examples, in the case of the chip type variable resistor described in the embodiments, the movable stopper may be provided on the ring-shaped sliding member. The insulating substrate may be made of a glass or a plastic, and the structure of the rotor may be modified as may be appropriate. Further, the present invention may be applied to many other variable electronic components such as a variable condenser, without limitation to the resistor.

1. A variable electronic component comprising:
an insulating substrate; and
a rotor rotatably mounted on an upper face of the insulating substrate;
wherein the rotor includes a movable stopper that is brought into direct contact with an outer surface of the insulating substrate for delimiting a maximum rotation angle of the rotor.

2. The variable electronic component according to claim 1,
wherein the rotor is made of a metal plate, the rotor including an upwardly open cup-shaped member with a flange outwardly extending from an upper end portion of the cup-shaped portion, and a ring-shaped sliding member disposed under the flange so as to surround the cup-shaped member;
wherein the flange of the cup-shaped member and the ring-shaped sliding member are integrally connected via a hinge portion;
wherein the cup-shaped member includes an engaging portion with which a rotation adjusting driver is engaged, while the ring-shaped sliding member includes a contact located opposite to the hinge portion across the center axis of the ring-shaped sliding member for contacting a characteristic adjusting film provided on the upper face of the insulating substrate; and
wherein the movable stopper is an armature downwardly extending to a lower level than the upper face of the insulating substrate from the flange of the cup-shaped member.

3. The variable electronic component according to claim 2,
wherein the movable stopper is located in a region opposite to the hinge portion on the flange of the cup-shaped member; and
wherein the insulating substrate includes an upwardly open groove or a stepped portion formed on the upper surface for allowing the movable stopper to rotate reciprocatively.

4. The variable electronic component according to claim 2, wherein the insulating substrate includes a stopper path that allows the movable stopper to intrude into a region inside a side face of the insulating substrate when the rotor is brought close to a rotational limit.

5. The variable electronic component according to claim 2, which is a chip type variable resistor, wherein the characteristic adjusting film is a resistor film.

6. The variable electronic component according to claim 1, wherein the insulating substrate includes a stopper path that allows the movable stopper to intrude into a region inside a side face of the insulating substrate when the rotor is brought close to a rotational limit.

7. The variable electronic component according to claim 6, wherein the insulating substrate includes an upwardly open groove formed on the upper surface along an arc for allowing the movable stopper to rotate reciprocatively, the stopper path being formed as an extension of the arc of the upwardly open groove.
